(19) United States
(12) Patent Application Publication
(10) Pub. No.: US 2011/0198042 A1
(43) Pub. Date: Aug. 18, 2011

(54) LIGHT-BLOCKING APPARATUS

(76) Inventor: Sang Beom Lee, Gyeonggi-do (KR)

(21) Appl. No.: 13/125,807

(22) PCT Filed: Jan. 26, 2010
(86) PCT No.: PCT/KR2010/000463

§ 371 Date: Apr. 23, 2011

(30) Foreign Application Priority Data
Jan. 29, 2009 (KR) 10-2009-0006976

(51) Int. Cl. A47H 23/04; E06B 9/24

(52) U.S. Cl. 160/121.1; 160/123

(57) ABSTRACT

The aim of the present invention is accomplished by providing a light-blocking apparatus comprising a curtain and a curtain frame in which the curtain is installed, wherein said curtain frame is formed into a square by sequentially coupling first to fourth frames, and each of the first to fourth frames has curtain grooves for installing first to fourth curtains, wherein said first to fourth curtains are open/shut in different directions.

### TECHNICAL FIELD

The present invention relates to a light-blocking apparatus, and more particularly, to a light-blocking apparatus which has four curtains installed therein and open and shut in different directions to thereby selectively set a light introducing location from windows and improve interior decoration effect by employing various colors and designs to each curtain.

### BACKGROUND ART

As various types of housings are introduced and the view is increasingly an important factor in housings, a part of living room or wall is formed by several windows or a single window, and such windows are very important factors within the house.

In general, such window blocks gaze from spectators or adjusts amount of sunshine by using a light-blocking apparatus such as curtains, blinds or verticals. More specifically, the curtain blocks light by being pulled to the center from opposite sides of the window. Blinds are moved from the upper side to the lower side to screen the outside or block light. Verticals are moved to the center from opposite sides of the window like curtains to screen the outside or block light, but may adjust the amount of light by adjusting angle.

As described above, a conventional light-blocking apparatus blocks light by moving a light-blocking layer from the upper side to the lower side or from one side to the other side, but does not open part of the window. That is, the conventional light-blocking apparatus cannot selectively open only a central part of the window or a lower part of one side of the window. Accordingly, the entire horizontal or vertical side of the window should be open as long as the light-blocking layer of the light-blocking apparatus is open. Thus, users have limited options for their preferences.

Once the light-blocking apparatus is installed, the color or design of the light-blocking layer cannot be changed, which may make the interior decoration monotonous.

### DISCLOSURE

### Technical Problem

The present invention has been made to solve the problems and it is an object of the present invention to provide a light-blocking apparatus which has four curtains installed therein and open and shut in different directions to thereby selectively set a light introducing location from windows and improve interior decoration effect by applying various colors and designs to each curtain.

### Technical Solution

In order to achieve the object of the present invention, a light-blocking apparatus which comprises a curtain and a curtain frame in which the curtain is installed comprises the curtain frame being sequentially coupled to first to fourth frames to be shaped in a square, wherein the first to fourth frames comprise a curtain groove to install first to fourth curtains therein, and the first to fourth curtains are open and shut in different directions.

The curtain frame in the square shape comprises an external frame and an internal frame formed in an inside of the external frame, wherein the external frame is formed by coupling first to fourth external frames formed in the first to fourth frames, wherein the internal frame is formed by coupling first to fourth internal frames formed in the first to fourth frames, wherein each of the first to fourth external frames formed in the first to fourth frames forms a side of the external frame, and each of the first to fourth internal frames formed in the first to fourth frames is ¼ thickness of the internal frame.

A curtain opening and shutting device is installed in each of the first to fourth frames to open and shut the first to fourth curtains and comprises a roll to which a curtain is rolled and which is installed in one side of each frame, a pulley support bar which is installed in another side of each frame to face the roll and comprises pulleys in opposite sides, and a wire which is connected to the curtain, and passes through the pulleys and is rolled and unrolled to/from the opposite ends of the roll to open and shut the curtain according to a rotation of the roll.

The curtain opening and shutting device further comprises a motor which is installed in one side of the roll and rotates the roll clockwise, and a motor driver which drives the motor.

The motor driver is controlled by a wireless control device.

### Advantageous Effect

A light-blocking apparatus according to the present invention has four curtains installed therein and open and shut in different directions to thereby selectively set a light introducing location from windows and improve interior decoration effect by employing various colors and designs to each curtain.

Also, the light-blocking apparatus according to the present invention has four curtains installed therein to keep the inside of the house warmer.

### BRIEF DESCRIPTION OF DRAWINGS

FIG. 1 illustrates a curtain frame 100 of a light-blocking apparatus according to the present invention.

FIG. 2 is an exploded view of the curtain frame 100 in FIG. 1.

FIG. 3 illustrates first to fourth frames 110 to 140 to which first to fourth curtains 111 to 141 are coupled.

FIG. 4 is an enlarged view of a curtain opening/shutting device 20 which is installed in the first frame among the curtain opening/shutting devices installed in the first to fourth frames 110 to 140.

FIG. 5 illustrates a light-blocking apparatus according to an exemplary embodiment of the present invention.

### DESCRIPTION OF NUMERALS FOR MAJOR PARTS IN THE DRAWINGS

100: curtain frame 11: external frame

12: internal frame 110: first frame

120: second frame 130: third frame

140: fourth frame

### BEST MODE

Hereinafter, preferable exemplary embodiments of the present invention will be described in detail with reference to drawings.

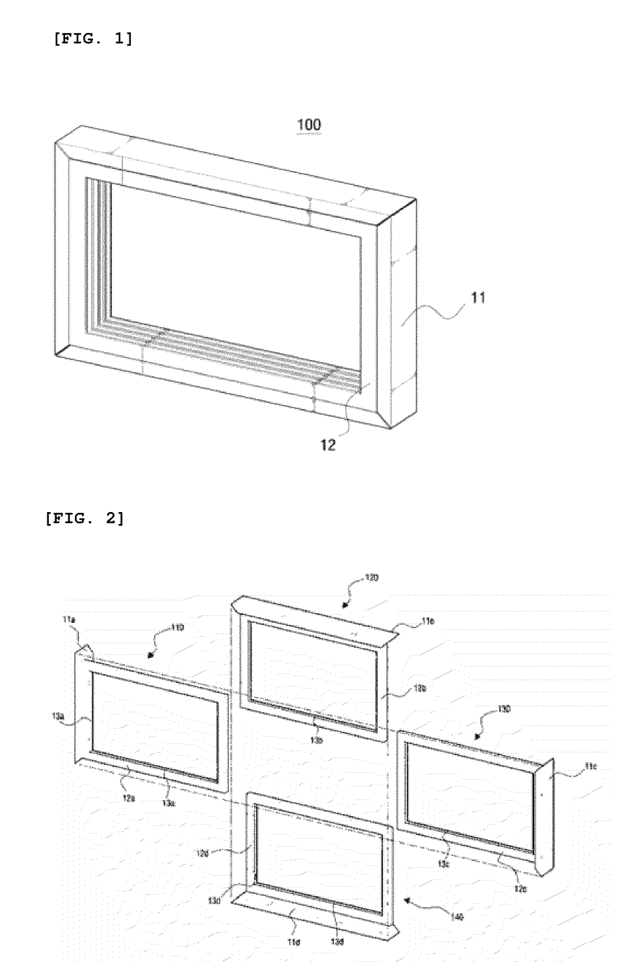

FIG. 1 illustrates a curtain frame 100 which is used in a light-blocking apparatus according to the present invention. The curtain frame 100 is installed in a front surface of a window, and is manufactured in a square according to the size of the window. The curtain frame 100 according to the present exemplary embodiment includes an external frame 11 which forms an external appearance of the entire curtain frame and an internal frame 12 which is formed in the inside of the external frame 11 and is coupled to the curtain.

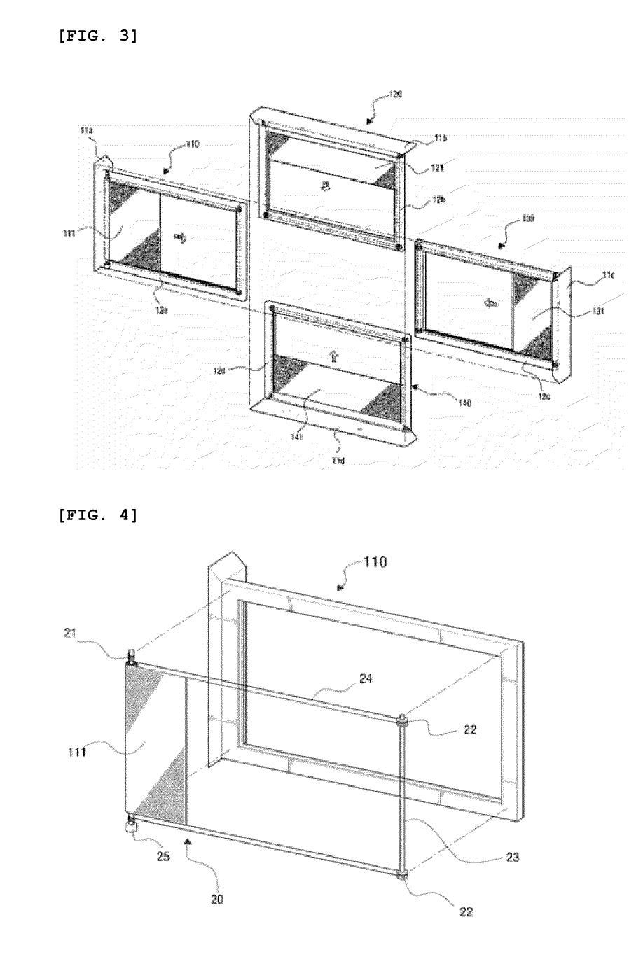

FIG. 2 is an exploded view of the curtain frame 100 in FIG. 1. As shown therein, the curtain frame 100 is coupled to first to fourth frames 110 to 140. According to the present exemplary embodiment, the first to fourth frames 110 to 140 are sequentially coupled to one another, but the sequence is not limited to the foregoing, and may vary.

The first frame 110 includes a first external frame 11a which forms the external frame 11 of the entire curtain frame 100, and a first internal frame 12a which forms the internal frame 12 of the entire curtain frame 100. The first external frame 11a forms one of four sides of the external frame 11 of the entire curtain frame 100 while the first internal frame 12a is formed in ¼ thickness of the internal frame 12 to form part of the internal frame 12 of the entire curtain frame 100. A curtain groove 13a is formed in four sides of the first internal frame 12a to install the curtain therein.

The second frame 120 includes a second external frame 11b which forms the external frame 11 of the entire curtain frame 100, and a second internal frame 12b which forms the internal frame 12 of the entire curtain frame 100. The second external frame 11b forms one of four sides of the external frame 11 of the entire curtain frame 100 while the second internal frame 12b is formed in ¼ thickness of the internal frame 12 to form part of the internal frame 12 of the entire curtain frame 100. The first internal frame 12a of the first frame 110 is coupled to a front surface of the second internal frame 12b. A curtain groove 13b is formed in four sides of the second internal frame 12b to install the curtain therein.

The third frame 130 includes a third external frame 11c which forms the external frame 11 of the entire curtain frame 100, and a third internal frame 12c which forms the internal frame 12 of the entire curtain frame 100. The third external frame 11c forms one of four sides of the external frame 11 of the entire curtain frame 100 while the third internal frame 12c is formed in ¼ thickness of the internal frame 12 to form part of the internal frame 12 of the entire curtain frame 100. The second internal frame 12b of the second frame 120 is coupled to a front surface of the third internal frame 12c. A curtain groove 13c is formed in four sides of the third internal frame 12c to install the curtain therein.

The fourth frame 140 includes a fourth external frame 11d which forms the external frame 11 of the entire curtain frame 100, and a fourth internal frame 12d which forms the internal frame 12 of the entire curtain frame 100. The fourth external frame 11d forms one of four sides of the external frame 11 of the entire curtain frame 100 while the fourth internal frame 12d is formed in ¼ thickness of the internal frame 12 to form part of the internal frame 12 of the entire curtain frame 100. The third internal frame 12c of the third frame 130 is coupled to a front surface of the fourth internal frame 12d. A curtain groove 13d is formed in four sides of the fourth internal frame 12d to install the curtain therein.

Accordingly, if the second to fourth internal frames 12b to 12d are sequentially provided in rear of the first internal frame 12a, the first to fourth external frames 11a to 11d are arranged clockwise. If the first to fourth frames 110 to 140 are coupled to one another, the entire curtain frame 100 in a square shape is formed.

According to the exemplary embodiment of the present invention, the entire curtain frame 100 includes the external frame 11 and the internal frame 12. However, the external frame 11 is required for beauty of the external appearance and may be omitted as applicable.

FIG. 3 illustrates the first to fourth frames 110 to 140 coupled to the first to fourth curtains 111 to 141. The first curtain 111 is coupled to the first internal frame 12a of the first frame 110 to move from the left side to the right side. The second curtain 121 is coupled to the second internal frame 12b of the second frame 120 to move from the upper side to the lower side. The third curtain 131 is coupled to the third internal frame 12c of the third frame 130 to move from the right side to the left side. The fourth curtain 141 is coupled to the fourth internal frame 12d of the fourth frame 140 to move from the lower side to the upper side. However, in the present invention, the first to fourth curtains 111 to 141 do not move only in the directions shown in drawings, and are installed to be open and shut in different directions. Accordingly, the first curtain 111 may move from the right side to the left side, the second curtain 121 may move from the lower side to the upper side, the third curtain 131 may move from the left side to the right side, and the fourth curtain 141 may move from the upper side to the lower side.

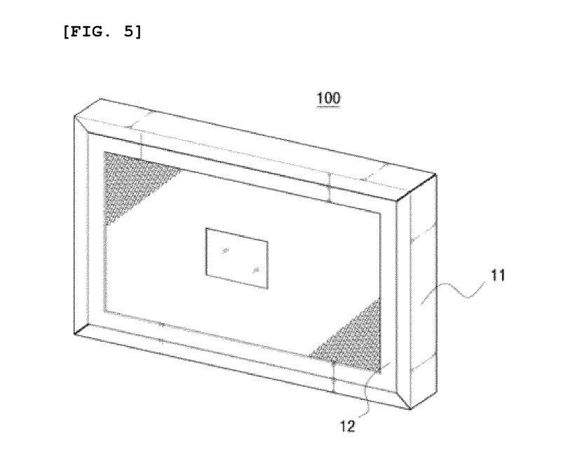

FIG. 4 is an enlarged view of a curtain opening and shutting device 20 which is installed in the first frame 110 among curtain opening and shutting devices installed in the first to fourth frames 110 to 140. The curtain opening and shutting apparatus 20 includes a roll 21 to which a curtain is rolled and which is installed in the internal frames of each frame, a pulley support bar 23 which is installed to face the roll 21 and has pulleys 22 in opposite sides thereof, and a wire 24 which is attached to the curtain rolled to the roll 21 and passes through the pulleys 22 and moves along with a rotation of the roll 21. The wire 24 is rolled or unrolled to/from the roll 21 according to the rotation of the roll 21 to thereby open and shut the curtain.

A motor 25 is installed in one side of the roll 21 to rotate the roll 21. More preferably, a motor driver (not shown) may be further attached to the motor 25 to rotate the motor 25 through an external input signal by using a wireless control device such as a remote controller.

FIG. 5 illustrates a light-blocking apparatus according to an exemplary embodiment of the present invention. As shown therein, the light-blocking apparatus according to the present invention may open any part of a window for sunshine or the outside. That is, if a user desires to open the central part of the window, he/she may move the first curtain installed in the first frame to the right side to locate the curtain adjacently to the central part, move the second curtain from the upper side to the lower side to locate the curtain adjacently to the central part, or move the third curtain from the right side to the left side to locate the curtain in the central part, and move the fourth curtain from the lower side to the upper side to locate the curtain in the central part to thereby form an opening part like a small window in the central part and have the sunshine or secure the outside view by manipulating the four curtains. As the opening part formed by the manipulation of the curtains may be formed in any other parts of the window, a user may selectively set the light introducing location.

If different colors and designs apply to each of four curtains, boredom due to a single curtain may be prevented and the interior decoration effect may be reinforced. Further, the curtains are installed in quadruple to keep the inside the house warmer.

Although the present invention has been described with reference to the embodiment described above, it is not limited to the embodiment, and the present invention may be modified in various ways without deviating from the scope of the present invention.

1. A light-blocking apparatus which comprises a curtain and a curtain frame in which the curtain is installed, the light-blocking apparatus comprising:
the curtain frame being sequentially coupled to first to fourth frames to be shaped in a square, wherein the first to fourth frames comprise a curtain groove to install first to fourth curtains therein, and the first to fourth curtains are open and shut in different directions.

2. The light-blocking apparatus according to claim 1, wherein the curtain frame in the square shape comprises an external frame and an internal frame formed in an inside of the external frame, wherein the external frame is formed by coupling first to fourth external frames formed in the first to fourth frames, wherein the internal frame is formed by coupling first to fourth internal frames formed in the first to fourth frames, wherein each of the first to fourth external frames formed in the first to fourth frames forms a side of the external frame, and each of the first to fourth internal frames formed in the first to fourth frames is ¼ thickness of the internal frame.

3. The light-blocking apparatus according to claim 1, wherein a curtain opening and shutting device is installed in each of the first to fourth frames to open and shut the first to fourth curtains and comprises a roll to which a curtain is rolled and which is installed in one side of each frame, a pulley support bar which is installed in another side of each frame to face the roll and comprises pulleys in opposite sides, and a wire which is connected to the curtain, and passes through the pulleys and is rolled and unrolled to/from the opposite ends of the roll to open and shut the curtain according to a rotation of the roll.

4. The light-blocking apparatus according to claim 3, wherein the curtain opening and shutting device further comprises a motor which is installed in one side of the roll and rotates the roll clockwise, and a motor driver which drives the motor.

5. The light-blocking apparatus according to claim 4, wherein the motor driver is controlled by a wireless control device.
